(19) United States
(12) Patent Application Publication
(10) Pub. No.: US 2020/0188842 A1
(43) Pub. Date: Jun. 18, 2020

(54) IMPROVED MEMBRANES FOR SEPARATING ALKENES FROM OTHER COMPOUNDS

(71) Applicant: Compact Membrane Systems, Inc., Newport, DE (US)

(72) Inventors: Kenneth Evan LOPRETE, Philadelphia, PA (US); Stuart Marshall NEMSER, Wilmington, DE (US)

(21) Appl. No.: 16/613,110

(22) PCT Filed: May 22, 2018
(86) PCT No.: PCT/US2018/033951

§ 371 Date: Nov. 12, 2019

Related U.S. Application Data
(60) Provisional application No. 62/505,567, filed on May 12, 2017.

(51) Int. Cl. B01D 53/22; B01D 69/12; B01D 71/36; B01D 71/34

(52) U.S. Cl. CPC B01D 53/228; B01D 69/12; B01D 2257/7022; B01D 71/34; B01D 2325/027; B01D 71/36

(57) ABSTRACT

Silver ionomers of fluorinated polymers are useful for separating alkenes from other compounds such as nitrogen, oxygen, carbon dioxide, and methane. In many instances the selectivities between the alkenes and other compounds are very high. These membranes are useful to recover alkenes and other gaseous compounds from processes in which an alkene is a starting material or product.

### FIELD OF THE INVENTION

This invention relates to the membrane separation of alkenes from gaseous species other than alkanes. More particularly, the present invention relates to types of fluorinated polymeric membranes suited for the facilitated transport of alkenes from mixtures of the alkenes with other gas which are not alkanes but may include nitrogen, oxygen, carbon dioxide, argon and compounds which are produced in the chemical conversion of olefins. The invention also includes the separation of methane from alkenes.

### BACKGROUND OF THE INVENTION

Alkenes, especially lower alkenes such as ethylene and propylene, are produced in huge quantities, and are basic chemical building blocks for the modern world. These alkenes are converted directly into polymers and other chemical compounds, and during these processes usually not all of the alkene is consumed. It would be desirable to recover the unused alkene from two viewpoints, to separate it from the desired product of the process, and also to reuse the alkene in that or another process thereby recovering the value of the unused alkene. Although purification of the desired product of the process may be necessary for one or more reasons, recovery of a sufficiently pure form of the alkene for reuse is of course dependent on having a recovery method that makes economic sense.

A very large use for ethylene and propylene is polymerization to make alkene homo- or copolymers. Typically after the polymers are formed they are shaped into pellets which, immediately after the polymerization, contain small amounts of the alkene, and small amounts of other materials, dissolved therein. These dissolved materials may be flammable and toxic and so must be removed before sale. Typically this is done in a “purge bin” by passing an inert gas such as nitrogen through the heated pellets to vaporize the dissolved (in the pellets) alkenes and other hydrocarbons. Recovery with purification of both the nitrogen and alkenes, in a form suitable for reuse, is of course desirable.

Other chemical processes which may be amenable to recovery of the starting alkene include manufacture of ethylene oxide and vinyl acetate, both made from ethylene.

It may also be desirable to recover other components that are used but not reacted in a process. The recovery of the nitrogen purge gas from an olefin polymerization resin is one example. Another is the recovery of nitrogen used in admixture with ethylene for fruit ripening. Alternatively the concentration of ethylene in the gas (nitrogen or air for instance) around the fruit can be regulated (reduced) to retard fruit ripening, for example if the fruit itself is generating ethylene. The gas stream may be purged of the ethylene allowing for its reuse in controlling the environment surrounding the fruit.

The separation of alkenes from alkanes using a membrane containing a silver ionomer of a fluorinated polymer is well known, see for instance U.S. Pat. No. 5,191,151, and International Patent Application Publication Nos. WO2015/009969, WO2016/182880, WO2016/182886, and WO2016/182889. However none of these documents mention the use of these types of membranes for separating other types of compounds from alkenes. The separation of methane from alkenes is also not mentioned. Although methane is generally considered an alkane, it lacks a corresponding olefin so is not referenced in the above patents and publications.

Facilitated transport membrane separation (“FTMS”) has arisen as an effective type of membrane process to separate alkenes from alkanes. Mass transfer via FTMS is accomplished by traditional solution diffusion coupled with a selectivity enhancing carrier mechanism. In early-developed, liquid state forms of FTMS, the carrier is in a liquid on the surface or in the pores of a membrane serving to maintain the liquid carrier adjacent to the feed side or immobilized within the membrane. The component which associates with the carrier is then discharged on the permeate side of the membrane. The silver ionomer membranes operate by a type of FTMS, but there is no separate traditional liquid phase.

Other types of membranes have been suggested for use in the separation of alkenes from nitrogen, see U.S. Pat. No. 5,879,431. The selectivities reported for nitrogen and ethylene at −40° C. ranged from 7 to 12, depending on the gas flow rate through the membrane apparatus. Commercially practical separation of many important mixtures containing alkenes has been difficult to accomplish using simple selectively permeable polymeric membranes, such as the membranes used in U.S. Pat. No. 5,879,431. Traditional polymeric membranes usually cannot discriminate well between the lower alkenes and other lower molecular weight compounds with commercially attractive productivities and selectivities because these compounds are often similar in both molecular size and physical properties, factors that often affect selective permeability.

Membrane separations of alkenes from the product streams of other chemical processes are reported in U.S. Patent Application Publication Nos. 2016/0075619, 2016/0075620, and 2017/0050900. None of these applications mentions the use of (fluorinated) silver ionomers in the separation membranes.

All patents, patent applications, references, articles, standards, and the like cited in this application are incorporated herein by reference in their entirety.

### SUMMARY OF THE INVENTION

This invention concerns a process for the membrane separation of an alkene from a second compound in a mixture comprising said alkene and said second compound, wherein the improvement comprises using said membrane which comprises a nonporous layer comprising a silver ionomer of a fluorinated polymer, and provided that said second compound is not an alkane containing 2 or more carbon atoms.

### DETAILED DESCRIPTION OF THE INVENTION

Herein certain terms are used, and some of them are defined below.

What is meant by a “fluorinated polymer” or “fluorinated ionomer” is of the total of the carbon-hydrogen groups and the carbon-fluorine groups in the polymer or ionomer, 30% or more are carbon fluorine groups, preferably 50% or more, very preferably 70% or more, especially preferably 90 percent or more are carbon-fluorine groups. By a carbon-hydrogen group is meant a hydrogen atom bound directly to a carbon atom, while a carbon-fluorine group is a fluorine atom bound directly to a carbon atom. Thus a —CF₂— group contains 2 carbon fluorine groups, while a —CH₃ group contains 3 carbon-hydrogen groups. Thus in a homopolymer of vinylidene fluoride, in which the repeat groups are —CH₂CF₂-the carbon-hydrogen groups and the carbon fluorine groups are each 50% of the total of carbon-hydrogen plus carbon-fluorine groups present. In a copolymer of 20 mole percent CF₂═CFOCF₂CF(CF₃)OCF₂CF₂SO₂F and 80 mole percent vinylidene fluoride the carbon-hydrogen groups are 27.6% of the total of the carbon-fluorine plus carbon hydrogen groups present. The relative amount of carbon-fluorine and carbon hydrogen groups present can be determined by elemental analysis or NMR spectroscopy, for instance using ¹⁴C NMR, or a combination of ¹⁹F and proton spectroscopy.

By an ionomer is meant the usual definition “A macromolecule in which a significant proportion of the constitutional units have ionizable or ionic groups, or both.” [modified slightly from the definition in Pure and Appl. Chem., 68 (12), p. 2299 (1996)]. The silver ionomer may be a silver salt of any strong acid, such as a sulfonic acid, fluorinated carboxylic acid, or the group —SO₂NHSO₂R¹ wherein R¹ is an alkyl group of 1 to 5 carbon atoms, optionally substituted by one or more fluorine atoms. A preferred R¹ groups is trifluoromethyl. Typically these silver salt groups are pendant to short branches on the main polymer chain.

By an alkane is meant a saturated hydrocarbon, preferably an acyclic saturated hydrocarbon, containing two or more carbon atoms. Methane is not included in the definition of an alkane, and may be the second compound, or a compound present in the mixture with the second compound.

Polymers useful in these membranes to form the silver ionomers, and the ionomers themselves are found in U.S. Pat. No. 5,191,151, U.S. Patent Application Publication No. US2015/0025293, and International Patent Application Publication Nos. WO2016/182880, WO2016/182883, WO2016/182886, WO2016/182887, and WO2016/182889. Typical repeat units in these polymers are derived from tetrafluoroethylene, trifluororethylene, vinylidene fluoride, vinyl fluoride, ethylene, and perfluorinated cyclic or cyclizable monomers. By a cyclic perfluorinated monomer is meant a perfluorinated olefin wherein a double bond of the olefin is in the ring or the double bond is an exo double bond wherein one end of the double bond is at a ring carbon atom. By a cyclizable perfluorinated monomer is meant a noncyclic perfluorinated compound containing two olefinic bonds that on polymerization forms a cyclic structure in the main chain of the polymer (see for instance N. Sugiyama, Perfluoropolymers Obtained by Cyclopolymereization and Their Applications, in J. Schiers, Ed., Modern Fluoropolymers. John Wiley & Sons, New York, 1997, p. 541-555, which is hereby included by reference). Such perfluorinated cyclic and cyclizable compounds include perfluoro(2,2-dimethyl-1,3-dioxole), perfluoro(2-methylene-4-methyl-1,3-dioxolane), perfluoroalkenyl perfluorovinyl ethers such as perfluoro-4-(1,2,2-trifluoroethenyloxy)-1-butene, and 2,2,4-trifluoro-5-trifluoromethoxy-1,3-dioxole.

It is preferred that the silver ionomer be a silver salt of a sulfonic acid. More preferably the sulfonic acid is a polymerized perfluorosulfonic acid (or derived from a monomer which contains a groups which may readily be converted to a sulfonic acid). Useful perfluorinated monomers containing a precursor to a sulfonic acid group include one or more of CF₂═CFOCF₂CF₂SO₂F, CF₂═CFOCF₂CF₂CF₂SO₂F and CF₂═CFOCF₂CF(CF₃)OCF₂CF₂SO₂F. The monomers CF₂═CFOCF₂CF(CF₃)OCF₂CF₂SO₂F and CF₂═CFOCF₂CF₂SO₂F are preferred.

In the silver ionomer, and its precursor acidic form, the repeat units that contain the pendant sulfonic acid (or readily converted to sulfonic) acid groups are preferably at least about 5 mole percent of the total repeat units present, more preferably at least about 10 mole percent, very preferably at least about 15 mole percent, and especially preferably at least about 22 mole percent. It is preferred that the repeat units that contain the pendant acid groups are no more than 45 mole percent of the repeat units present in the silver ionomer or its precursor acid form. It is to be understood that any minimum amount of such repeat units and any maximum amount of such repeat units may be combined to form a preferred range of the amount of these repeat units.

In one preferred form the silver ionomer has no melting point above about 0° C. with a heat of fusion of 3 J/g or more when measured by Differential Scanning calorimetry using ASTM Test D3418-12e1 using a heating rate of 10° C./min, and measured on the second heat.

It is preferred that this layer be as thin as possible in order that the amount of permeate through this layer be maximized. In one typical and preferred configuration the solid (nonporous) layer containing the silver ionomer is all ionomer. A minimum average thickness of the ionomer layer is preferably less than 1.0 μm, more preferably less than 0.5 μm and especially preferably about 0.2 μm, and the maximum thickness is preferably 10 μm, more preferably about 5 μm, and very preferably about 2 μm. It is to be understood that any minimum thickness of the ionomer layer may be combined with any maximum thickness to form a preferred thickness range.

If the thickness of the ionomer layer is on the order of urn's or less, it may not be self-supporting. Therefore it is often laminarly contacting a thicker support layer of a microporous polymer which provides physical strength. In another preferred configuration, there are three layers, an ionomer layer laminarly contacting a high diffusion rate layer, which in turn is laminarly contacting a (thicker) layer of microporous polymer. Such constructions are described in International Patent Application Publication No. WO2016/182887.

As those skilled in the art will understand, the materials used in the complete membrane should be deleteriously affected by any of the process streams they may come into contact with. It is generally believed in the art that fluoropolymers are more resistant to chemical reagents than unfluorinated polymers, and that the higher the fluorine content of the polymer the more resistant they are. This is not just to chemical reaction but also resistance to swelling and/or dissolution by the process materials.

In particular the silver ionomer may be subject to chemical reaction, perhaps because of silver ion's propensity to be reduced or otherwise compromised. Materials that “poison” the silver ionomer, i.e., render it inoperative in carrying out the desired separation, should be avoided in the separation process. For instance it is believed that H₂S renders the silver ionomer ineffective, and so probably should be avoided (see International Patent Application Publication No. WO2016/182883). Whether a particular component of a process stream, or the whole process stream itself, is deleterious to the operation of the silver ionomer may be readily determined by testing the component or stream with a particular membrane.

Preparation and/or sources of the polymers containing pendant acidic groups, preparation of the silver ionomers, and the preparation of these membranes are known in the art, and will be found in U.S. Pat. No. 5,191,151, and International Patent Application Publication Nos. WO2015/009969, WO2016/182880, WO2016/182886, WO2016/182889, and WO2016/182887.

In a preferred embodiment of the separation process using the silver ionomer, the mixture to be separated and the permeate through the membrane are both gases. This is referred to herein as a gas phase separation process.

It is to be understood that besides the alkene and second compound in the mixture to be separated other compounds may also be present in that mixture. This may include one or more other alkenes and/or one or more compounds other than the second compound. It is believed that generally speaking most alkenes will be “favored” to be in the permeate of the membrane.

A preferred separation is that of an alkene from nitrogen. Preferred alkenes are one or more of ethylene, propylene, and a butene. Preferably the selectivity of alkene to nitrogen is about 10 or more, more preferably about 20 or more, and especially preferably about 50 or more. Preferably this selectivity is determined at ambient temperature, about 20±2° C.

The present process using the silver ionomer has another advantage in that while the alkene permeates readily through the silver ionomer, the analogous alkane does not. By an analogous alkane is meant the alkane that one would obtain by hydrogenation of the alkene. For instance ethane is the analogous alkane of ethylene, propane is the analogous alkane of propylene, and n-butane is the analogous alkane of 2-butene. Typically in most processes in which an alkene is used as a starting material, such as the polymerization of ethylene or propylene, the analogous alkane is usually considered an inert material. If the analogous alkane is not separated from the alkene, it may be merely recycled back into the reaction system, and will build up in the reaction system unless vented or otherwise disposed of. Since the analogous alkane does not readily pass through the membrane with the alkene, it will not build up in the reaction system (see for instance U.S. Pat. Nos. 6,271,319 and 6,414,202). Preferably the selectivity of alkene to analogous alkane is about 5 or more, more preferably about 10 or more, and especially preferably about 20 or more, and very preferably 30 or more. Preferably this selectivity is determined at ambient temperature, about 20±2° C. Preferred alkenes to be separated include ethylene, propylene, a butene, and 1-pentene, and ethylene and propylene are more preferred. It is to be understood that any preferred alkene may be combined with any preferred second compound in a preferred process.

This invention is now illustrated by examples of certain representative embodiments thereof. Proportions and percentages are by weight unless otherwise indicated. Certain abbreviations used in the examples are defined by their Chemical Abstracts Names or structures below:

| | |
|---|---|
| PDD | 4,5-difluoro-2,2-bis(trifluoromethyl)-1,3-dioxole |
| PPSF | 1,1,2,2-tetrafluoro-2-[(1,2,2-trifluoroethenyl)oxy]- |
| | ethanesulfonylfluoride |
| PSEPVE | 2-[1-[difluoro[(1,2,2-trifluoroethenyl)oxy]methyl]- |
| | 1,2,2,2-tetrafluoroethoxy]-1,1,2,2-tetrafluoroethanesulfonyl |
| | fluoride |
| VF | fluoroethene |
| HFPO | CF₃CF₂CF₂OCF(CF₃)C(O)OOC(O)CF(CF₃)OCF₂CF₂CF₃ |
| dimer | |
| peroxide | |

### EXAMPLES

### Example 1. Permeance and Selectivity Measurements

For determinations of permeance (GPU, reported in units of sec/cm²·s·cm Hg) and selectivity the following procedure is used. A 47 mm flat disc membrane is punched from a larger flat sheet 3 inch (16.6 cm) composite membrane. The 47 mm disc is then placed in a stainless steel cross flow testing cell comprised of a feed port, retentate port, a sweep inlet port, and a permeate port. Four hex bolts are used to tightly secure the membrane in the testing cell with a total active area of 13.85 cm².

The cell is placed in a testing apparatus comprising of a feed line, a retentate line, optionally, a sweep line, and a permeate line. The feed consists of a mixture of an alkene gas and a second compound gas. Each gas is supplied from a separate cylinder. For alkene, usually a polymer grade compound is used and for second compound, a reagent grade compound is used. The two gases are then fed to their respective mass flow controllers where a mixture of any composition can be made. Concentrations of the alkene in the mixture are 20 to 80 mole percent, preferably 20 mole percent, with the second compound being the remainder (not including the water vapor). The mixed gas is fed through a water bubbler to humidify the gas mixture bringing the relative humidity to greater than 90%. A back pressure regulator is used in the retentate line to control the feed pressure to the membrane. The feed pressure is kept at 60 psig (0.41 MPa), and after the back pressure regulator the gas is vented. Generally, there is no sweep gas on the permeate side of the membrane. After the cell is connected to all the lines and pressurized, the system is allowed to reach a steady state by permeating for 30 min before a GC sample is taken.

The permeate line consists of the permeated gas through the membrane as well as water vapor. The permeate is connected to a three-way valve so flow measurements could be taken. A Varian® 450 GC gas chromatograph (GC) with a GS-GasPro capillary column (0.32 mm, 30 m) was used to analyze the ratio of the alkene and the second compound in the permeate stream. The pressure in the permeate side is typically between 1.20 and 1.70 psig (8.3 to 11.7 kPa gauge). Experiments were carried out at room temperature (20±2° C.).

During the measurement the following are recorded: feed pressure, permeate pressure, temperature, sweep-in flow rate (nitrogen+water vapor) and total permeate flow rate (permeate+water vapor).

From the results recorded the following were determined: all individual feed partial pressures based on feed flows and feed pressure; all individual permeate flows based on measured permeate flow, sweep flows, and composition from the GC; all individual permeate partial pressures based on permeate flows and permeate pressures. From these the transmembrane partial pressure difference of individual components were calculated. From the equation for permeance

Qᵢ=Fᵢ/(A·Δpᵢ)

wherein, Qᵢ=permeance of species ‘i’, Fᵢ=Permeate flow rate of species ‘i’ Δpᵢ=transmembrane partial pressure difference of species ‘i’, and A is the area of the membrane (13.85 cm²), the permeance (Qᵢ) was calculated.

The selectivity is calculated by dividing the permeance of the alkene by the permeance of the second compound.

### Example 2. Fabrication of a Representative High-Diffusion Rate Layer (HDL)

A 0.3%-w/w solution of Teflon® AF 2400 (The Chemours Co., Wilmington, Del. 19899, USA; for further information about Teflon® AF, see P. R. Resnick, et al., Teflon AF Amorphous Fluoropolymers, J. Schiers, Ed., Modern Fluoropolymers, John Wiley & Sons, New York, 1997, p. 397-420) was prepared in Fluorinert® 770 (available from 3M Corp., 3M Center, St. Paul, Minn., USA) and filtered through a glass microfiber filter with a porosity of approximately 1-μm. A porous layer support (PLS) comprised of a 1′×4′ (2.5×10.2 cm) flat sheet of porous polyacrylonitrile (PAN), with a molecular weight cutoff of 150 k, designated PAN350 membrane and made by Nanostone Water, 10250 Valley View Rd., Eden Prairie, Minn. 53344, USA. (The PAN350 membrane is an ultrafilter made from polyacrylonitrile) and supported on a non-woven polyester backing was placed on a level casting table. The AF 2400 solution was applied to the PAN starting at one end and cast with a Mayer rod at a constant speed. A dry-air purged and vented cover was placed over the “wet” film, which was allowed to dry at ambient temperature for at least 1 hr. Several 47-mm disks were cut from the HDL and tested with nitrogen in a pressure cell. The nitrogen permeance was between 2600 and 4000-GPU, corresponding to an effective HDL layer thickness of approximately 0.1 to 0.2-μm.

### Example 3. Fabrication of Representative Thin-Film Composite Membranes (TCMs) with a PDD/VF/PSEPVE Selective Layer (SL)

A 0.85%-w/w solution of a terpolymer comprising repeat units of 1,1,2,2-tetrafluoro-2-({1,1,1,2,3,3-hexafluoro-3-[(trifluoroethenyl)oxy]propan-2-yl}oxy)ethanesulfonyl fluoride(PSEPVE), perfluoro-2,2-dimethyldioxole (PDD) and vinyl fluoride (VF), herein referred to as PDD/VF/PSEPVE, and described in Example 1 of PCT application WO2016/182889, was prepared by dissolving the solid acid-form polymer (AFP) in a 70/30 w/w mixture of isopropanol and Novec® HF 7300 (reportedly 1,1,1,2,2,3,4,5,5,5-decafluoro-3-methoxy-4-trifluromethylpentane and available from 3M Corp., Electronic Markets Materials Div., St. Paul, Minn., 55144, USA) The solution was filtered through a glass microfiber filter with a porosity of approximately 1-μm. The PDD/VF/PSEPVE AFP had an equivalent weight of approximately 800-g/mole.

A 3″-(7.6 cm) dia. disk of the supported HDL of example 2 was placed between two 3″ (7.6 cm) OD thin stainless-steel rings. The HDL surface (38.3-cm) was then covered (contacted) with an AFP solution. After 10 to 30 seconds, the HDL surface was slightly tilted and the excess AFP solution was pipetted away from the surface. The “wet” AFP film was quickly weighed and then dried for a minimum of 1-hour in a level orientation at ambient temperature in a ventilated enclosure that was gently purged with nitrogen. The dry TCM was heat treated for 5 minutes at 90° C. in a forced-air circulating oven. After cooling to ambient temperature, the AFP surface of the TCM was covered with a solution of 0.5M aqueous silver nitrate. After an appropriate time, the excess silver nitrate solution was removed. The surface was lightly rinsed with de-ionized water and any adventitious drops were removed with an air purge.

### Example 4. Permeance Measurements

Using the procedures of example 1 for measuring alkene/(analogous) alkane and alkene/second compound permeances and selectivities the membrane as prepared in Example 3 was tested. Results are given in Table 1. The alkene/nitrogen tests were done with a mixture of 20% alkene and 80% nitrogen.

TABLE 1

| | |
|---|---|
| Alkene | Second Compound |

| Type | Permeance | Type | Permeance | Selectivity |
|---|---|---|---|---|
| propylene | 152.6 | propane | 4.61 | 33 |
| ethylene | 178.3 | ethane | 4.64 | 38 |
| propylene | 195.4 | nitrogen | 3.28 | 60 |
| ethylene | 173.9 | nitrogen | 3.26 | 53 |

### Example 5. Permeance Measurements

Using the procedures of example 1, the alkene and methane permeances and selectivities were measured using the membrane as prepared in Example 3. Results are given in Table 2. The alkene/methane tests were done with a mixture of 10%, 30%, and 50% propylene and 90%, 70%, and 50% methane, respectively.

TABLE 2

| | |
|---|---|
| Alkene | Second Compound |

| Type | Permeance | Type | Permeance | Selectivity |
|---|---|---|---|---|
| propylene | 335.8 | methane | 2.05 | 163.8 |
| (10%) | | (90%) | | |
| propylene | 193.9 | methane | 2.12 | 91.6 |
| (30%) | | (70%) | | |
| propylene | 121.1 | methane | 2.52 | 48.0 |
| (50%) | | (50%) | | |

what is claimed is:

1. A process for the gas phase membrane separation of an alkene from a second compound in a mixture comprising said alkene and said second compound, wherein said membrane comprises a nonporous layer comprising a silver ionomer of a fluorinated polymer, and provided that said second compound is not an alkane of two or more carbon atoms.

2. The process as recited in claim 1, wherein said alkene is ethylene and/or propylene, and said second compound is nitrogen.

3. The process as recited in claim 1, wherein said alkene is ethylene and/or propylene and said second compound is methane.

4. The process as recited in claim 1, wherein said second compound is argon.

5. The process as recited in claim 1, wherein said fluorinated polymer is comprised of repeat units derived from a monomer of the formula CF₂═CF(OR_{f})SO₂F and repeat units derived from one or more cyclic or cyclizable perfluorinated monomers, wherein R_{f} is perfluoroalkylene having 2 to 20 carbon atoms, optionally substituted by ether oxygens.

6. The process recited in claim 5, wherein the cyclic or cyclizable perfluorinated monomers are selected from the group perfluoro(2,2-dimethyl-1,3-dioxole), perfluoro(2-methylene-4-methyl-1,3-dioxolane), perfluoroalkenyl perfluorovinyl ethers such as perfluoro-4-(1,2,2-trifluoroethenyloxy)-1-butene, and 2,2,4-trifluoro-5-trifluoromethoxy-1,3-dioxole.

7. The process recited in claim 5, wherein the monomer of formula CF₂═CF(OR_{f})SO₂F is CF₂═CFOCF₂CF(CF₃)OCF₂CF₂SO₂F or CF₂═CFOCF₂CF₂SO₂F.

8. The process of claim 5, wherein the fluorinated polymer is further comprised of repeat units selected from the group tetrafluoroethylene, chlorotrifluoroethylene, trifluoroethylene, vinylidene fluoride, or vinyl fluoride.
